(19) United States
(12) Patent Application Publication
(10) Pub. No.: US 2018/0284632 A1
(43) Pub. Date: Oct. 4, 2018

(54) LIQUID DEVELOPER AND LIQUID DEVELOPER CARTRIDGE

(71) Applicant: FUJI XEROX CO., LTD., Tokyo (JP)

(72) Inventors: Fumiaki MERA, Kanagawa (JP); Daisuke YOSHINO, Kanagawa (JP); Masahiro OKI, Kanagawa (JP); Yoshitake OGURA, Kanagawa (JP); Takako KOBAYASHI, Kanagawa (JP); Kazusei YOSHIDA, Kanagawa (JP); Manabu KAWASHIMA, Kanagawa (JP); Akira IMAI, Kanagawa (JP); Tetsuya TAGUCHI, Kanagawa (JP)

(73) Assignee: FUJI XEROX CO., LTD., Tokyo (JP)

(21) Appl. No.: 15/796,367

(22) Filed: Oct. 27, 2017

(30) Foreign Application Priority Data
Mar. 29, 2017 (JP) 2017-065370

(51) Int. Cl. G03G 9/13; G03G 9/08; G03G 9/135; G03G 9/125; G03G 9/087; G03G 15/08; G03G 15/10

(52) U.S. Cl. CPC G03G 9/132; G03G 9/0802; G03G 9/135; G03G 15/10; G03G 9/08755; G03G 15/0865; G03G 9/125

(57) ABSTRACT

A liquid developer includes toner particles and a carrier liquid, wherein the toner particles include, as a binder resin, an amorphous polyester resin and a crystalline saturated aliphatic polyester resin having a composition ratio (C/O ratio) of carbon atoms and oxygen atoms of 3.4 or less, and with respect to a toner obtained by vacuum drying the toner particles, a crystal melting peak at a first temperature rise in differential heating calorimetry is 60° C. or more.

### CROSS-REFERENCE TO RELATED APPLICATIONS

This application is based on and claims priority under 35 USC 119 from Japanese Patent Application No. 2017-065370 filed Mar. 29, 2017.

### BACKGROUND

### 1. Technical Field

The present invention relates to a liquid developer and a liquid developer cartridge.

### 2. Related Art

As a developer used for electrophotographic image formation, a liquid developer in which toner particles are dispersed in a carrier liquid is known.

### SUMMARY

According to an aspect of the invention, there is provided a liquid developer including:

toner particles; and

a carrier liquid,

wherein the toner particles include, as a binder resin, an amorphous polyester resin and a crystalline saturated aliphatic polyester resin having a composition ratio (C/O ratio) of carbon atoms and oxygen atoms of 3.4 or less, and with respect to a toner obtained by vacuum drying the toner particles, a crystal melting peak at a first temperature rise in differential heating calorimetry is 60° C. or more.

### BRIEF DESCRIPTION OF THE DRAWING

Exemplary embodiments of the present invention will be described in detail based on the following figure, wherein:

FIG. 1 is a schematic configuration diagram showing an example of an image forming apparatus according to the exemplary embodiment.

### DETAILED DESCRIPTION

A description will be given below of an exemplary embodiment which is an example of the present invention. These descriptions and examples are illustrative of the exemplary embodiment and do not limit the scope of the invention.

In the exemplary embodiment, in a case of referring to the amount of each component in the composition, in a case where there are plural types of substances corresponding to each component in the composition, the amount means the total amount of the plural types of substances present in the composition unless otherwise specified. In the exemplary embodiment, the meaning of “(meth)acrylic” includes both “acrylic” and “methacrylic”.

### <Liquid Developer>

The liquid developer according to the exemplary embodiment includes toner particles and a carrier liquid, in which the toner particles include an amorphous polyester resin and a crystalline saturated aliphatic polyester resin as a binder resin, a composition ratio (C/O ratio) of carbon atoms and oxygen atoms of the crystalline saturated aliphatic polyester resin is 3.4 or less, and a crystal melting peak at a first temperature rise in differential heating calorimetry, obtained by drying the toner particles, is 60° C. or more.

First, it is considered that the storage stability, the low-temperature fixability, and the like of the toner particles are improved by adding a crystalline polyester resin as the binder resin in the toner particles, since the viscosity of the crystalline polyester resin changes greatly from before to after the crystal melting and the difference in temperature from the start of the thermal activation of the molecules until the melting is a comparatively small.

However, the crystalline polyester resin is hydrophobic as compared with the amorphous polyester resin and it is estimated that, in a case where the crystalline polyester resin contacts a similarly hydrophobic carrier liquid, plasticization of the contact portion is more likely to occur as compared with the amorphous polyester resin.

When the crystalline polyester resin present on the surface of the toner particles is plasticized in the liquid developer, the aggregation of the toner particles or the adhesion to the transfer member at the time of transfer is increased and transfer defects (also referred to as “hollow characters”) may occur, and such phenomena are often observed after storage (heat storage), particularly at high temperatures (40° C. or higher).

Therefore, in the liquid developer according to the exemplary embodiment, the composition ratio (C/O ratio) of carbon atoms and oxygen atoms of the crystalline saturated aliphatic polyester resin is 3.4 or less, and a crystal melting peak at a first temperature rise in differential heating calorimetry, obtained by drying the toner particles, is 60° C. or more.

With this configuration, even in a case where a crystalline polyester resin is used as the binder resin in the toner particles, it is possible to obtain a liquid developer excellent in heat storability. Although the mechanism for obtaining such an effect is not clear, it is presumed to be as follows.

When the C/O ratio of the crystalline saturated aliphatic polyester resin included in the toner particles is 3.4 or less, the crystalline saturated aliphatic polyester resin becomes more hydrophilic and plasticization upon contact with the carrier liquid is prevented, in addition, when the crystal melting peak at a first temperature rise in differential heating calorimetry, obtained by drying the toner particles, is 60° C. or more, plasticization of the toner particles and the carrier liquid during heat storage is prevented and it is considered that the heat storability is excellent.

In addition, it is considered that, when brought into contact with the carrier liquid, plasticization of the saturated aliphatic polyester resin is prevented to a greater extent than in the unsaturated aliphatic polyester resin and that the heat storability of the saturated aliphatic polyester resin is superior.

It is presumed that the liquid developer according to the exemplary embodiment having the configuration described above is excellent in heat storability due to the above mechanisms working together.

A detailed description will be given below of the liquid developer according to the exemplary embodiment.

### (Toner Particles)

The liquid developer according to the exemplary embodiment includes toner particles.

In addition, the toner particles include an amorphous polyester resin and a crystalline saturated aliphatic polyester resin as a binder resin, a composition ratio (C/O ratio) of carbon atoms and oxygen atoms of the crystalline saturated aliphatic polyester resin is 3.4 or less, and a crystal melting peak at a first temperature rise in differential heating calorimetry, obtained by drying the toner particles, is 60° C. or more.

The toner particles may include a binder resin, a colorant, and a release agent. In addition, the toner particles may be transparent toner particles not including a colorant. An external additive maybe attached to the surface of the toner particles.

The toner particles maybe toner particles with a single layer structure or so-called core-shell structure toner particles formed of a core (core particle) and a coating layer (shell layer) covering the core.

The toner particles have a crystal melting (Tm) peak at a first temperature rise in differential heating calorimetry, obtained by drying the toner particles, of 60° C. or more.

In the exemplary embodiment, the differential heating calorimetry is performed according to the following conditions.

### <Toner Drying Conditions>

After collecting two 15 g samples of liquid developer as a developer, each sampled liquid is put into a centrifuge tube, installed in a centrifugal separator (MX-301 manufactured by TOMY SEIKO CO., LTD.), subjected to centrifugation at 10,000 rpm for 5minutes, and then the carrier liquid, which is a supernatant liquid, is removed and the solid matter precipitated by centrifugation is collected on an aluminum dish. After placing the developer collected on the aluminum dish into a vacuum dryer, vacuum suction is carried out to achieve an air pressure of an atmospheric pressure of −0.1 MPa or less, a temperature of 30° C. and an atmospheric pressure of −0.1 MPa or less are maintained for 17 hours, a dry toner is obtained, and this toner is used in the analysis.

### <Conditions for Measuring Crystal Melting Peak (Tm)>

A DSC curve measured by differential scanning calorimetry is measured based on ASTM D 3418-99.

For the measurement, a differential scanning calorimeter (DSC-60A, manufactured by SHIMADZU Corporation) is used, the temperature correction of the apparatus detection part is carried out by using the melting temperatures of indium and zinc, and the melting heat of indium is used for the calorific correction.

An aluminum pan is used for the measurement sample, the pan is set as the control, and measurement is performed.

Specifically, 8 mg of the toner is set in a sample holder of DSC-60 A, the temperature is made to rise for the first time from 0° C. to 150° C. at a heating rate of 10° C./min, and the crystal melting peak (Tm) is calculated with DSC-60A analysis software.

From the viewpoint of the low temperature fixability and heat storability, the crystal melting (Tm) peak is preferably from 60° C. to 80° C., more preferably from 60° C. to 75° C., even more preferably from 62° C. to 72° C., and particularly preferably from 63° C. to 69° C.

In addition, in the toner particles in the liquid developer according to the exemplary embodiment, the glass transition temperature (Tg) peak at a first temperature rise in differential heating calorimetry, obtained by drying the toner particles, is preferably from 45° C. to Tm, more preferably from 48° C. to Tm, and particularly preferably from 50° C. to less than 60° C.

The glass transition temperature (Tg) peak in the exemplary embodiment is assumed to be measured by differential heating calorimetry similar to the measurement of the crystal melting (Tm) peak, and the glass transition temperature (Tg) peak may be measured together with the crystal melting (Tm) peak at the first temperature rise at which the measurement of the crystal melting (Tm) peak is performed.

The volume average particle diameter of the toner particles included in the liquid developer is preferably from 0.1 μm to 6 μm, more preferably from 0.1 μm to 4 μm, and even more preferably from 0.5 μm to 3 μm.

The volume particle diameter distribution index (GSDv) of the toner particles included in the liquid developer is preferably 1.5 or less, and more preferably 1.25 or less.

A description will be given below of the material of the toner particles.

### Binder Resin

The toner particles used in the exemplary embodiment include an amorphous polyester resin and a crystalline saturated aliphatic polyester resin as a binder resin.

From the viewpoint of the low temperature fixability and heat storability, the content of the crystalline saturated aliphatic polyester resin in the toner particles is preferably from 1% by weight to 50% by weight with respect to the total weight of the binder resin included in the toner particles, more preferably from 5% by weight to 40% by weight, even more preferably from 10% by weight to 30% by weight, and particularly preferably from 15% by weight to 25% by weight.

As the binder resin of the toner particles, a polyester resin is preferable. For the polyester resin, an amorphous polyester resin and a crystalline polyester resin may be used in combination. In a case where a crystalline polyester resin is used, the ratio of the crystalline polyester resin to the total binder resin is preferably from 2% by weight to 40% by weight (preferably from 2% by weight to 20% by weight).

In addition, it is preferable that the toner particles used in the exemplary embodiment do not include a crystalline unsaturated aliphatic polyester resin and a crystalline aromatic polyester resin as a binder resin.

“Crystallinity” of the resin in the exemplary embodiment means that a clear endothermic peak is exhibited in differential heating calorimetry (DSC) rather than a stepwise change in the endothermic amount, specifically, that the half-width of the endothermic peak when measured at a heating rate of 10° C./min is 10° C. or less. “Non-crystallinity” of the resin means that the half-width of the endothermic peak exceeds 10° C., that a stepwise change in the endothermic amount is exhibited, or that a clear endothermic peak is not observed.

### [Crystalline Saturated Aliphatic Polyester Resin]

The composition ratio (C/O ratio) of the carbon atoms and oxygen atoms of the crystalline saturated aliphatic polyester resin used in the exemplary embodiment is 3.4 or less.

The composition ratio (C/O ratio) of the carbon atoms and the oxygen atoms of the crystalline saturated aliphatic polyester resin is calculated by identifying the structure of the crystalline saturated aliphatic polyester resin.

The method for identifying the structure of the crystalline saturated aliphatic polyester resin is not particularly limited and may be selected from known methods such as a nuclear magnetic resonance method, gas chromatographic weight spectrometry, liquid chromatographic weight spectrometry, thermal decomposition-gas chromatographic weight spectrometry, chemical decomposition-gas chromatographic weight spectrometry, a method in which two or more known methods are combined, or the like.

From the viewpoint of the low temperature fixability and heat storability, the C/O ratio is preferably from 2.0 to 3.4 or less, more preferably from 2.3 to 3.4 or less, and particularly preferably from 2.5 to 3.3 or less.

The crystalline saturated aliphatic polyester resin is preferably a resin obtained by polycondensation of at least a saturated aliphatic dicarboxylic acid and a saturated aliphatic diol, and more preferably a resin obtained by polycondensation of a saturated aliphatic dicarboxylic acid and a saturated aliphatic diol.

In addition, from the viewpoint of the low temperature fixability and heat storability, the crystalline saturated aliphatic polyester resin is preferably a resin having a constituent unit represented by formula (1), more preferably a resin having 80% by weight or more of a constituent unit represented by formula (1) with respect to the total weight of the resin, even more preferably a resin having 90% by weight or more of a constituent unit represented by formula (1) with respect to the total weight of the resin, and particularly preferably a resin having 95% by weight or more of a constituent unit represented by formula (1) with respect to the total weight of the resin.

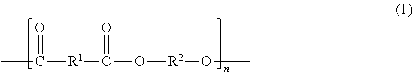

In formula (1), R¹ and R² each independently represent an alkylene group, and the total number of carbon atoms of R¹ and R² is 13 or less. Since the number of oxygen atoms in formula (1) is 4, the number of carbon atoms is 13 or less such that the composition ratio (C/O ratio) of the carbon atoms and the oxygen atoms is 3.4 or less. R¹ and R² need not each be of the same type. Specifically, for example, in the case of sebacic acid (10 carbon atoms) and ethylene glycol (2 carbon atoms), the total number of carbon atoms of R¹ and R² is 12 and the C/O ratio is 3.0. In addition, in a case where sebacic acid and adipic acid (6 carbon atoms) are included in the same molar acid component, since R¹ has an average of 8 carbon atoms, the total number of carbon atoms of R¹ and R² is 10, and the (C/O ratio) is 2.5.

Here, n represents a number of 2 or more.

R¹ and R² may each independently be a linear alkylene group or a branched alkylene group, but from the viewpoint of the low temperature fixability and heat storability, a linear alkylene group is preferable.

From the viewpoint of the low temperature fixability and heat storability, R¹ preferably has from 2 to 11 carbon atoms, more preferably from 2 to 10, even more preferably from 4 to 10, and particularly preferably from 6 to 8.

From the viewpoint of the low temperature fixability and heat storability, R² preferably has from 2 to 11 carbon atoms, more preferably from 2 to 10, even more preferably from 2 to 8, and particularly preferably from 4 to 6.

From the viewpoint of the low temperature fixability and heat storability, the total number of carbon atoms of R¹ and R² is preferably from 6 to 12, more preferably from 8 to 12, and particularly preferably from 8 to 10.

n is the number of repetitions of the constituent unit represented by formula (1), and n may be a number of 2 or more. In addition, n may be a number corresponding to the weight average molecular weight of the crystalline saturated aliphatic polyester resin.

Examples of saturated aliphatic dicarboxylic acids include oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, anhydrides thereof, lower (for example, having from 1 to 5 carbon atoms) alkyl esters thereof, and the like.

Among the above, preferable examples thereof include dicarboxylic acids selected from the group consisting of sebacic acid, 1,9-nonanedicarboxylic acid, and 1,10-decanedicarboxylic acid.

In addition, a trivalent or higher saturated aliphatic carboxylic acid having a cross-linked structure or a branched structure, anhydrides thereof, or lower alkyl esters thereof (for example, having from 1 to 5 carbon atoms) may be used in combination with the saturated aliphatic dicarboxylic acid.

Furthermore, a dicarboxylic acid having a sulfonic acid group may be used in combination with the saturated aliphatic dicarboxylic acid.

As the saturated aliphatic dicarboxylic acid, one type maybe used alone or two or more types may be used in combination.

Examples of saturated aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, and the like.

Among the above, preferable examples thereof include dicarboxylic acids selected from the group consisting of ethylene glycol, 1,3-propanediol, and 1,4-butanediol.

In addition, a trivalent or higher saturated aliphatic alcohol having a cross-linked structure or a branched structure may be used in combination with the saturated aliphatic diol. Examples of trivalent or higher saturated aliphatic alcohols include glycerin, trimethylolethane, trimethylolpropane, pentaerythritol, and the like.

As the saturated aliphatic diol, one type may be used alone or two or more types may be used in combination.

From the viewpoint of the low temperature fixability and heat storability, the crystal melting peak (Tm) of the crystalline saturated aliphatic polyester resin is preferably from 60° C. to 110° C., more preferably from 65° C. to 95° C., even more preferably from. 70° C. to 90° C., and particularly preferably from 70° C. to 80° C.

The crystal melting peak is obtained from a DSC curve obtained by differential heating calorimetry (DSC). Specifically, the crystal melting peak is obtained based on “melting peak temperature” described in the method for determining the crystal melting peak in “Testing Methods for Transition Temperatures of Plastics” JIS K 7121: 1987.

As the crystalline saturated aliphatic polyester resins, one type may be used alone or two or more types may be used in combination.

The weight average molecular weight (Mw) of the crystalline saturated aliphatic polyester resin is preferably more than 5,000, more preferably 6,000 or more, and even more preferably 10,000 or more, and preferably 35,000 or less. The number average molecular weight (Mn) of the crystalline polyester resin is preferably 2,000 or more, and more preferably 4,000 or more.

### [Amorphous Polyester Resin]

The toner particles used in the exemplary embodiment include an amorphous polyester resin as a binder resin.

From the viewpoint of the low temperature fixability and heat storability, the SP value (unit: (cal/cm3) ^{1/2}) of the amorphous polyester resin used in the exemplary embodiment is preferably from 9.50 to 10.00, more preferably from 9.60 to 9.95, even more preferably from 9.70 to 9.90, and particularly preferably from 9.75 to 9.85.

Here, in the exemplary embodiment, the SP value is calculated by Fedor's method. Specifically, the SP value is calculated by the following equation.

Equation: SP value=√/(Ev/v)=√(ΣΔei/ΣΔvi)

(In the equation, Ev: evaporation energy (cal/mol), v: molar volume (cm³/mol), Δei: evaporation energy of each atom or atomic group, Δvi: molar volume of each atom or atomic group)

Details of this calculation method are described in Polym. Eng. Sci., Vol. 14, p. 147 (1974), Junji Mukai et al., “Practical Polymers for Engineers”, page 66 (KODANSHA LTD., 1981), Polymer Handbook (4^{th} Edition, A Willey-interscience Publication), and the like, and the same method is also applied in the exemplary embodiment.

In the exemplary embodiment, (cal/cm³) ^{1/2} is adopted as the unit of SP value, but, according to custom, the units are omitted and the description is given without dimensions.

It is also possible to measure the SP value of the resin, for example, by the following method, without being limited to the following method.

As an example of the measurement of the SP value, there is a method in which, the resin is dissolved in a good solvent, then titration of a poor solvent is implemented, certain printed characters are set to be visible, the time until the solution clouds such that the printed characters are unable to be determined is set as the poor solvent titration end point, and the SP value is calculated from the titration amount. For example, two solutions are prepared in which 0.3 g of resin is sufficiently dissolved in 20 mL of THF (may be dioxane or the like) thermostated at 30° C.

There is a method in which a high polarity solvent (for example, water) is dropped into one solution and the titration endpoint is determined and a low polarity solvent (for example, hexane is preferable, but hexadecane or the like may be used) is dropped into another solution and the titration end point is determined.

In the SP value calculation method, the calculation is made from the titration amount by the following equation derived from Flory-Huggins's interaction parameter calculation formula.

δP={δm1*(Vm1)^{0.5}+δmh*(Vm1)^{0.5}}/{(Vm1)^{0.5}+(Vm1)^{0.5}}

δm1, Vm1, δmh, and Vmh are determined using formula (2) and formula (3) using the titration amounts with each of the solvents.
ϕ: volume fraction
V: molar volume (=molecular weight/density)
δm1, Vm1 . . . in a case of being titrated with a low polarity solvent (for example, hexane).
δmh, Vmh: in a case of being titrated with a high polarity solvent (for example, water).

However, δm=ϕ1δ1+ϕ2δ2 (2)

Vm=V1V2/(ϕ1V2+ϕ2V1) (3)

1 and 2 in the formulas are the solvents of the polymer solution and 2 is the solvent used for the titration.

Although it is also possible to measure the SP value by this method, the measurement is not limited to this method.

In the exemplary embodiment, the value measured by the method described above is calculated as the measured SP value.

Examples of amorphous polyester resins include a polycondensate of a polyvalent carboxylic acid and a polyol.

Examples of polyvalent carboxylic acids include aliphatic dicarboxylic acids (for example, oxalic acid, malonic acid, maleic acid, fumaric acid, citraconic acid, itaconic acid, glutaconic acid, succinic acid, alkenylsuccinic acid, adipic acid, sebacic acid, and the like), alicyclic dicarboxylic acid (for example, cyclohexane dicarboxylic acid, and the like), aromatic dicarboxylic acids (for example, terephthalic acid, isophthalic acid, phthalic acid, naphthalenedicarboxylic acid, and the like), anhydrides thereof, lower (for example, having from 1 to 5 carbon atoms) alkyl esters thereof, or the like. Among these, for example, an aromatic dicarboxylic acid is preferable as the polyvalent carboxylic acid.

As the polyvalent carboxylic acid, a trivalent or higher carboxylic acid having a cross-linked structure or a branched structure may be used together with the dicarboxylic acid. Examples of trivalent or higher carboxylic acids include trimellitic acid, pyromellitic acid, anhydrides thereof, lower (for example, having 1 to 5 carbon atoms) alkyl esters thereof, or the like.

As the polyvalent carboxylic acid, one type may be used alone or two or more types may be used in combination.

Examples of polyols include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, ethylene oxide adducts of bisphenol A, propylene oxide adducts of bisphenol A, and the like). Among these, the polyol is preferably, for example, an aromatic diol or an alicyclic diol, and more preferably an aromatic diol.

As the polyol, a trivalent or higher polyol having a cross-linked structure or a branched structure may be used in combination with the diol. Examples of trivalent or higher polyols include glycerin, trimethylolpropane, and pentaerythritol.

As the polyol, one type may be used alone or two or more types may be used in combination.

The glass transition temperature (Tg) of the amorphous polyester resin is preferably from 50° C. to 80° C., more preferably from 50° C. to 65° C., and even more preferably from 55° C. to 65° C.

The glass transition temperature is obtained from a DSC curve obtained by differential heating calorimetry (DSC). Specifically, the glass transition temperature is based on “Extrapolated Glass Transition Starting Temperature” described in the method for determining the glass transition temperature in “Method for Measuring Plastic Transition Temperature” JIS K 7121: 1987.

The weight average molecular weight (Mw) of the amorphous polyester resin is preferably from 5,000 to 1,000,000, more preferably from 7,000 to 500,000, even more preferably from 8,000 to 30,000, and particularly preferably from 8,000 to 20,000. The number average molecular weight (Mn) of the amorphous polyester resin is preferably from 2,000 to 100,000. The molecular weight distribution Mw/Mn of the amorphous polyester resin is preferably from 1.5 to 100, and more preferably from 2 to 60.

It is possible to obtain the amorphous polyester resin and the crystalline saturated aliphatic polyester resin by a known production method. Specifically, for example, the amorphous polyester resin and the crystalline saturated aliphatic polyester resin are obtained by a method in which the polymerization temperature is set to from 180° C. to 230° C., the pressure in the reaction system is reduced as necessary, and the reaction is carried out while removing water and alcohol generated during the condensation.

In a case where the monomer of the material does not dissolve or compatibilize at the reaction temperature, a solvent having a high boiling point may be added as a dissolution aid to carry out dissolution. In such a case, the polycondensation reaction is carried out while the dissolution aid is distilled off. In the case where a monomer having poor compatibility is present in the copolymerization reaction, it is preferable to condense a monomer having poor compatibility with an acid or an alcohol to be polycondensed with the monomer beforehand, and then carry out the polycondensation reaction with the main component.

In the toner particles used in the exemplary embodiment, from the viewpoint of fixability, the total content of the binder resin is preferably from 40% by weight to 95% by weight with respect to the total weight of the toner particles, more preferably from 50% by weight to 90% by weight, and even more preferably 60% by weight to 85% by weight.

### Colorant

The toner particles used in the exemplary embodiment preferably include a colorant.

The colorant is not particularly limited, and a known colorant is used.

Examples of colorants include pigments such as carbon black, chrome yellow, Hansa yellow, benzidine yellow, threne yellow, quinoline yellow, pigment yellow, permanent orange GTR, pyrazolone orange, vulcan orange, Watchung Red, permanent red, brilliant Carmine 3B, Brilliant Carmine 6B, Du Pont oil red, pyrazolone red, lysol red, rhodamine B lake, lake red C, pigment red, Rose Bengal, aniline blue, ultramarine blue, calco oil blue, methylene blue chloride, phthalocyanine blue, Pigment Blue, phthalocyanine green, malachite green oxalate, and the like; acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, thiazole dyes, and the like.

One type of these colorants may be used alone or two or more types may be used in combination.

As the colorant, a surface-treated colorant may be used as necessary, and the colorant maybe used in combination with a dispersant. In addition, plural types of colorants may be used in combination.

The content of the colorant is, for example, preferably from 1% by weight to 30% by weight with respect to the total weight of the toner particles, more preferably from 1% by weight to 20% by weight, and even more preferably from 3% by weight to 15% by weight.

### Release Agent

The toner particles used in the exemplary embodiment preferably include a release agent.

Examples of release agents include low molecular weight polyolefins such as polyethylene, polypropylene, and polybutene; silicones; fatty acid amides such as oleic acid amide, erucic acid amide, ricinoleic acid amide, and stearic acid amide; plant waxes such as carnauba wax, rice wax, candelilla wax, wood wax, and jojoba oil; animal waxes such as beeswax; mineral waxes such as montan wax, ozokerite, ceresin, paraffin wax, microcrystalline wax, and Fischer-Tropsch wax; petroleum waxes; and the like. One type of these release agents may be used alone or two or more types may be used in combination.

The crystal melting of the release agent is preferably from. 50° C. to 110° C., and more preferably from 60° C. to 100° C. The crystal melting of the release agent is determined from a DSC curve obtained by differential heating calorimetry (DSC). Specifically, the crystal melting of the release agent is based on the “melting peak temperature” described in the method for determining the crystal melting in “Method for Measuring Plastic Transition Temperature” JIS K 7121: 1987.

The content of the release agent is, for example, preferably from 0.5% by weight to 50% by weight with respect to all of the toner particles, more preferably 1% by weight to 30% by weight, even more preferably from 1% by weight to 20% by weight, and still more preferably from 5% by weight to 15% by weight.

### Other Additives

Examples of other additives include known additives such as magnets, charge-controlling agents, inorganic powder, and the like. These additives are included in toner particles as internal additives.

### External Additives

The toner particles used in the exemplary embodiment may have an external additive on the surface of the toner particles including the binder resin.

Examples of external additives include inorganic particles. The inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, Ca₃(PO₄)₂, and the like.

The surface of the inorganic particles as an external additive is preferably subjected to a hydrophobic treatment. The hydrophobic treatment is carried out, for example, by immersing inorganic particles in a hydrophobizing agent, or the like. The hydrophobizing agent is not particularly limited and examples thereof include silane coupling agents, silicone oil, titanate coupling agents, aluminum coupling agents, and the like. One type of these may be used alone or two or more types may be used in combination. The amount of hydrophobizing agent is, for example, 1 part by weight or more to 10 parts by weight or less with respect to 100 parts by weight of the inorganic particles.

Examples of external additives also include resin particles (resin particles such as polystyrene, polymethyl methacrylate, melamine resin, polyester resin, and silicone resin), cleaning aids (for example, metal salts of higher fatty acids represented by zinc stearate, particles of fluorine high molecular weight polymers), and the like.

The external addition amount of the external additives is preferably from 0.01% by weight to 5% by weight with respect to the total weight of the toner particles, and more preferably from 0.01% by weight to 2.0% by weight.

### (Carrier Liquid)

The liquid developer according to the exemplary embodiment includes a carrier liquid.

The carrier liquid is an insulating liquid for dispersing toner particles. The carrier liquid may be either non-volatile or volatile, but a non-volatile carrier liquid is preferable. In the liquid developer according to the exemplary embodiment, the insulating property means that the electrical conductivity is 10¹⁰ S/m or less, and non-volatility means that the flash point is 130° C. or higher, or that the volatilization amount when kept on standing for 24 hours at 150° C. is 8% by weight or less. The flash point is the temperature measured according to JIS K 2265-4: 2007.

Examples of carrier liquids include hydrocarbons (aliphatic hydrocarbons and aromatic hydrocarbons, also referred to as “mineral oils”); silicone oils such as dimethyl silicone oil, methyl hydrogen silicone oil, and methylphenyl silicone oil; polyol compounds such as ethylene glycol, diethylene glycol, and propylene glycol; and the like. One type thereof may be used alone or two or more types may be used in combination.

Here, the mineral oil in the exemplary embodiment includes not only hydrocarbons derived from underground resources such as petroleum, natural gas, and coal, but also hydrocarbons obtained by refining and denaturing such hydrocarbons.

In the liquid developer according to the exemplary embodiment, the carrier liquid preferably includes hydrocarbons (mineral oil), and more preferably has hydrocarbons as a main component. The main component of the carrier liquid is a chemical substance making up 50% by weight or more of the entire carrier liquid. Examples of hydrocarbons include aliphatic hydrocarbons such as isoparaffin, normal paraffin, naphthene and olefin, and aromatic hydrocarbons. One type may be used alone or two or more types may be used in combination. As the carrier liquid, aliphatic hydrocarbons are preferable, paraffin is more preferable, and isoparaffin is even more preferable. The ratio of hydrocarbons (preferably aliphatic hydrocarbons, and more preferably paraffin) with respect to the entire carrier liquid is preferably 50% by weight or more, more preferably 80% by weight or more, even more preferably 90% by weight or more, particularly preferably 95% by weight or more, and the carrier liquid is most preferably substantially only hydrocarbon.

Examples of commercially available hydrocarbons include hydrocarbons such as ISOPAR L (isoparaffin), ISOPAR M (isoparaffin), EXXOL D80 (naphthene), EXXOL D110 (naphthene), SOLVESSO 100 (aromatic hydrocarbons), and SOLVESSO 150 (aromatic hydrocarbons) manufactured by EXXON MOBIL Corporation; “MORESCO WHITE P-40” (paraffin), “MORESCO WHITE P-100” (paraffin), and “MORESCO WHITE P-200” (paraffin) manufactured by MORESCO Corporation; NAPHTESOL 200 “(naphthene) and NAPHTESOL 220” (naphthene) manufactured by JXTG NIPPON OIL & ENERGY Corporation, and the like.

### (Other Components)

The liquid developer according to the exemplary embodiment may include, for example, a dispersant, an emulsifier, a surfactant, a stabilizer, a wetting agent, a thickener, a foaming agent, a defoaming agent, a coagulant, a gelling agent, an anti-settling agent, a charge-controlling agent, an anti-static agent, an anti-oxidant, a softening agent, a filler, a perfuming agent, an anti-blocking agent, a release agent, and the like.

These compounds are preferably dissolved or dispersed in a carrier liquid.

### Dispersant

The dispersant is not particularly limited, and a known dispersant (a low molecular dispersant or a polymer dispersant) is used, but a polymer dispersant is preferable. One type of these dispersants may be used alone or two or more types may be used in combination.

From the viewpoint of the dispersion stability of toner particles, the polymer dispersant is preferably a “polymer amine compound having an amino group” which adsorbs to the surface of toner particles (the acid component of the polyester resin). The polymer amine compound having an amino group also functions as a positively chargeable charge-controlling agent.

Examples of polymer amine compounds include a polyalkyleneimine compound, a polyallylamine compound, a polydiallylamine compound, a polyvinylamine compound, a polyvinylpyrrolidone compound, and the like.

The polyalkyleneimine compound is a polymer amine compound having a polyalkylimine structure, and examples thereof include polyalkyleneimine, polyalkyleneimine (“SOLSPERSE 11200” (manufactured by Lubrizol Corporation)), where a poly (carbonylalkyleneoxy) chain is bonded as a side chain by amide cross-linking, a reaction product (“SOLSPERSE 13940” (manufactured by Lubrizol Corporation)) of polyalkyleneimine and a self-condensate of 12-hydroxystearic acid, and the like.

The polyallylamine compound is a polymer amine compound having a polyallylamine structure, and examples thereof include a homopolymer of one type of allylamine, a copolymer of plural types of allylamines, a copolymer of polydiallylamine and polyallylamine, and the like. Suitable examples of polyallylamine include a copolymer represented by formula (PAA).

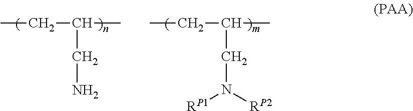

In formula (PAA), R^{P1} and R^{P2} each independently represent a hydrogen atom or an aliphatic hydrocarbon group having 1 to 20 carbon atoms. n and m each independently represent an integer of from 1 to 10,000.

In formula (PAA), it is preferable that R^{P1} and R^{P2} each independently represent an aliphatic hydrocarbon group having 1 to 20 carbon atoms. The aliphatic hydrocarbon group having 1 to 20 carbon atoms maybe either a linear or branched aliphatic hydrocarbon group. Examples of aliphatic hydrocarbon groups include a methyl group, an ethyl group, a propyl group, a butyl group, a pentyl group, a hexyl group, an octyl group, and the like. The aliphatic hydrocarbon group is preferably a methyl group.

n and m each independently preferably represents an integer of from 5 to 1,000, and more preferably an integer of from 80 to 1,000.

The polydiallylamine compound is a polymer amine compound having a polydiallylamine structure, and examples thereof include a polymer of one type of polydiallylamine, plural types of polydiallylamine copolymers, a copolymer of polydiallylamine and polyallylamine, and the like.

The polyvinylpyrrolidone compound is a polymer amine compound having a polyvinylpyrrolidone structure and examples thereof include a random copolymer or graft copolymer of poly (N-vinyl-2-pyrrolidone) and N-vinyl-2-pyrrolidone and a (meth)acrylate alkyl ester or an alkylene compound (“ANTARON V 220”, “ANTARON V 216” (the above are manufactured by ISP TECHNOLOGIES)), and the like.

Among these, from the viewpoint of the dispersion stability and chargeability of the toner particles, the polymer amine compound is preferably at least one type selected from the group consisting of a polyalkyleneimine compound and a polyallylamine compound.

From the viewpoint of the dispersion stability and chargeability of the toner particles, the weight average molecular weight of the polymer dispersant (particularly a polymer amine compound) is preferably from 1,000 to 1,000,000, and more preferably from 2,000 to 100,000.

From the viewpoint of the dispersion stability and chargeability of the toner particles, the content of the polymer dispersant is preferably from 0.01 parts by weight to 50 parts by weight with respect to 100 parts by weight of the toner particles, and more preferably from 0.1 part by weight to 5 parts by weight.

From the viewpoint of chargeability, the liquid developer according to the exemplary embodiment preferably includes a charge-controlling agent.

The charge-controlling agent used in the exemplary embodiment is not particularly limited and charge-controlling agents known in the related art are used. Examples thereof include positively chargeable charge-controlling agents such as nigrosine dyes, fatty acid modified nigrosine dyes, carboxyl group-containing fatty acid modified nigrosine dyes, quaternary ammonium salts, amine compounds, amide compounds, imide compounds, and organometallic compounds; negatively chargeable charge-controlling agents such as metal complexes of oxycarboxylic acid, metal complexes of azo compounds, metal complex salt dyes and salicylic acid derivatives, and the like. The charge-controlling agent may be only one type or may be two or more types.

In particular, from the viewpoint of chargeability, the liquid developer according to the exemplary embodiment preferably includes a positively chargeable charge-controlling agent, and more preferably includes at least one compound selected from the group consisting of a maleimide compound, a toluenesulfonamide compound, a metal soap of octylic acid (2-ethylhexanoate), a metal soap of octanoic acid, and a metal soap of naphthenic acid.

From the viewpoint of chargeability, the content of the charge-controlling agent in the liquid developer according to the exemplary embodiment is preferably from 0.001 parts by weight to 10 parts by weight with respect to the total weight of the liquid developer, and more preferably from 0.005 parts by weight to 5 parts by weight.

### (Method for Producing Liquid Developer)

The liquid developer according to the exemplary embodiment is produced through, for example, a granulation step of preparing coarse toner particles and a wet pulverization step of pulverizing coarse toner particles in a carrier liquid.

The granulation step may be either a dry production method (for example, a kneading and pulverizing method) or a wet production method (for example, an aggregation coalescence method, a suspension polymerization method, or a dissolution suspension method). These production methods are not particularly limited, and known production methods may be adopted. It is preferable to obtain coarse toner particles in a dry state by subjecting the coarse toner particles obtained by the wet production method to a washing step, a solid-liquid separation step, and a drying step. The dry coarse toner particles and external additives may be mixed and an external additive may be adhered to the surface of coarse toner particles.

In the wet pulverization step, after coarse toner particles are dispersed in a carrier liquid, the coarse toner particles are wet-pulverized in a carrier liquid, for example, using a media type wet pulverizer such as a bead mill, a ball mill, a sand mill, an attritor, or the like.

As another example, the liquid developer according to the exemplary embodiment is produced, for example, by preparing toner particles in a solvent by a wet production method and replacing the solvent with a carrier liquid as necessary. In this production method, the wet production method may be any of an aggregation coalescence method, a suspension polymerization method, a dissolution suspension method, or the like, and a known production method may be adopted. As the solvent to be used in the wet production method, the same type of solvent as the carrier liquid, a solvent which is able to replace the carrier liquid (for example, a solvent having a lower boiling point than the carrier liquid), or a mixed solvent thereof is preferable.

The content of the toner particles in the liquid developer according to the exemplary embodiment is preferably from 10 parts by weight to 35 parts by weight with respect to 100 parts by weight of the carrier liquid.

### <Liquid Developer Cartridge>

The liquid developer cartridge according to the exemplary embodiment includes a container that contains the liquid developer according to the exemplary embodiment and is detachable from the image forming apparatus. The liquid developer contained in the liquid developer cartridge according to the exemplary embodiment, for example, is supplied to the developing unit of the image forming apparatus through a supply pipe provided in the image forming apparatus. The shape of the liquid developer cartridge according to the exemplary embodiment is not particularly limited, and examples thereof include a tank shape and a bottle shape. The capacity of the liquid developer cartridge according to the exemplary embodiment may be selected according to the size of the image forming apparatus.

### <Image Forming Apparatus and Image Forming Method>

In the image forming apparatus according to the exemplary embodiment, the liquid developer according to the exemplary embodiment is used as a liquid developer.

The image forming apparatus according to the exemplary embodiment is preferably provided with an image holding member, a charging unit which charges a surface of the image holding member, an electrostatic charge image forming unit which forms an electrostatic charge image on the charged surface of the image holding member, a developing unit which contains the liquid developer according to the exemplary embodiment and which develops the electrostatic charge image formed on the surface of the image holding member as a toner image using the liquid developer, a transfer unit which transfers the toner image formed on the surface of the image holding member onto the surface of a recording medium, and a fixing unit which fixes the toner image transferred to the surface of the recording medium.

The image forming apparatus according to the exemplary embodiment carries out an image forming method (the image forming method according to the exemplary embodiment) which has a charging step of charging a surface of an image holding member, an electrostatic charge image forming step of forming an electrostatic charge image on the charged surface of the image holding member, a developing step of developing the electrostatic charge image formed on the surface of the image holding member as a toner image using the liquid developer according to the exemplary embodiment, a transfer step of transferring the toner image formed on the surface of the image holding member to the surface of the recording medium, and a fixing step of fixing the toner image transferred to the surface of the recording medium.

The image forming apparatus according to the exemplary embodiment preferably includes image forming apparatuses such as, for example, a direct transfer type apparatus which directly transfers a toner image formed on the surface of the image holding member onto a recording medium; an intermediate transfer type apparatus which primarily transfers a toner image formed on the surface of the image holding member onto the surface of an intermediate transfer member and secondarily transfers the toner image transferred to the surface of the intermediate transfer member onto the surface of the recording medium; an apparatus provided with a cleaning unit for cleaning the surface of the image holding member before charging after transferring the toner image; an apparatus provided with an erasing unit for irradiating the surface of the image holding member with erasing light to erase the charge before charging and after transferring the toner image; and the like. In the case where the image forming apparatus according to the exemplary embodiment is an intermediate transfer type apparatus, the transfer unit has, for example, an intermediate transfer member to which a toner image is transferred on the surface, a primary transfer unit which primarily transfers the toner image formed on the surface of the image holding member onto the surface of the intermediate transfer member, and a secondary transfer unit which secondarily transfers the toner image transferred to the surface of the intermediate transfer member to the surface of the recording medium.

In the image forming apparatus (image forming method) according to the exemplary embodiment, it is preferable that the fixing apparatus (fixing step) perform fixing in two stages. Specifically, the fixing apparatus (fixing step) preferably is a non-contact heating apparatus (non-contact heating step) which heats the toner image in a non-contact manner, and a heating and pressing apparatus (heating and pressing step) for applying pressure while heating after the heating by the non-contact heating apparatus (after the non-contact heating step).

The recording medium is not particularly limited, and a known recording medium is used. Examples thereof include a thermoplastic resin film, paper, an OHP sheet, and the like. Uses of the thermoplastic resin film include labels, packaging materials, posters, and the like.

Examples of thermoplastic resin films include polyolefin films such as polyethylene and polypropylene; polyester films such as polyethylene terephthalate and polybutylene terephthalate; polyamide films such as nylon; films such as polycarbonate, polystyrene, modified polystyrene, polyvinyl chloride, polyvinyl alcohol, and polylactic acid; and the like. These films may be either unstretched films, or uniaxially or biaxially stretched films. The thermoplastic resin film may be in the form of a single layer or a multilayer film. The thermoplastic resin film may be a film having a surface coat layer for assisting the fixing of the toner particles, or a film subjected to a corona treatment, an ozone treatment, a plasma treatment, a flame treatment, a glow discharge treatment or the like. The thickness of the thermoplastic resin film for use in the soft packaging material is, for example, preferably from 5 μm to 250 μm or less, and more preferably from 10 μm to 100 μm.

In the following, a description will be given of the image forming apparatus according to the exemplary embodiment with reference to the drawing.

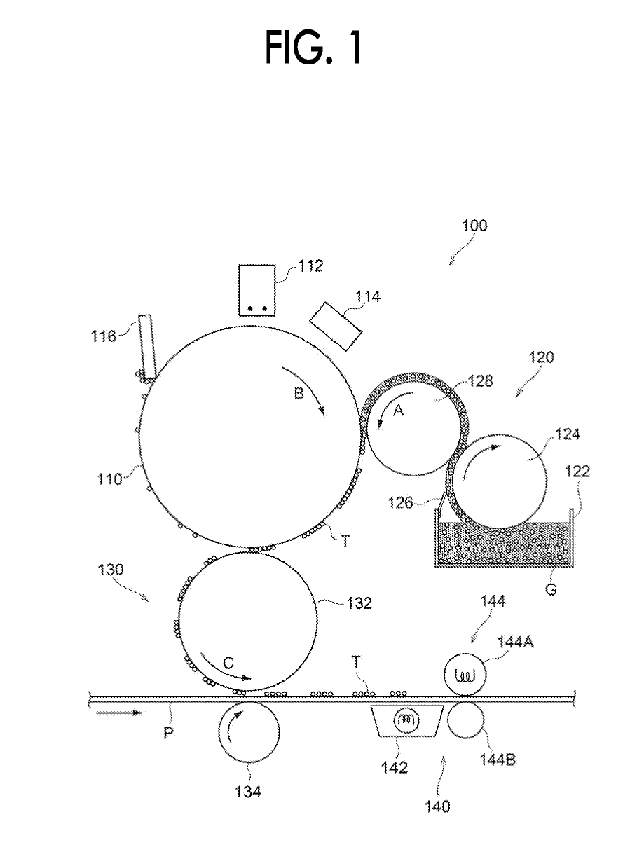

FIG. 1 is a schematic configuration diagram of an example of an image forming apparatus according to the exemplary embodiment.

An image forming apparatus 100 shown in FIG. 1 is provided with a photoreceptor 110 (an example of an image holding member), a charging apparatus 112 (an example of a charging unit), an exposure apparatus 114 (an example of an electrostatic charge image forming unit), a developing apparatus 120 (an example of a developing unit), a transfer apparatus 130 (an example of a transfer unit), a fixing apparatus 140 (an example of a fixing unit), and a cleaner 116.

The photoreceptor 110 has a cylindrical shape and the charging apparatus 112, the exposure apparatus 114, the developing apparatus 120, the transfer apparatus 130, and the cleaner 116 are provided in order around the photoreceptor 110.

The charging apparatus 112 charges the surface of the photoreceptor 110.

The exposure apparatus 114 forms an electrostatic charge image by exposing the charged surface of the photoreceptor 110 with a laser beam, for example, based on an image signal.

The developing apparatus 120 is provided with a developer accommodating container 122, a developer supply roller (anilox roller) 124, a regulating member 126, and a developing roller 128.

The developer accommodating container 122 contains the liquid developer G. A stirring member (not shown) for stirring the liquid developer G may be provided in the developer accommodating container 122.

The developer supply roller 124 is provided so that a part thereof is immersed in the liquid developer G contained in the developer accommodating container 122 and is brought close to (or in contact with) the developing roller 128, and the liquid developer G in the developer accommodating container 122 is supplied to the surface of the developing roller 128. The regulating member 126 controls the supply amount of the liquid developer G through the developer supply roller 124.

The developing roller 128 holds the liquid developer G supplied from the developer supply roller 124 and develops the electrostatic charge image formed on the surface of the photoreceptor 110 as a toner image T using the liquid developer G.

The transfer apparatus 130 is an intermediate transfer type apparatus provided with a drum-shaped intermediate transfer member 132 to which the toner image T formed on the surface of the photoreceptor 110 is transferred and a transfer roller 134 which transfers the toner image T transferred on the surface of the intermediate transfer member 132 to the recording medium P.

The transfer apparatus 130 may, for example, have a configuration provided with a belt-shaped intermediate transfer member 132, or may have a direct transfer type configuration which transfers the toner image T to the recording medium P directly from the photoreceptor 110 using the transfer roller 134 without being provided with the intermediate transfer member 132.

The fixing apparatus 140 is provided on the downstream side of the transfer apparatus 130 in the traveling direction of the recording medium P, and is provided with a non-contact heating apparatus 142 and a heating and pressing apparatus 144.

The non-contact heating apparatus 142 is, for example, a plate-shaped heating apparatus provided with a heat source inside a metal housing. The non-contact heating apparatus 142 may be provided with a blowing apparatus together with a heat source inside the housing. The non-contact heating apparatus 142 may be provided on the side of the recording medium on which the toner image is formed, may be provided on the back side (the side on which the toner image is not formed) of the recording medium, or may be provided on both sides.

The heating and pressing apparatus 144 is, for example, a pair of a heating roller 144A and a pressing roller 144B. The heating roller 144A and the pressing roller 144B are arranged to be opposed to each other so as to nip the recording medium therebetween. A heat source is provided inside the heating roller 144A. In addition, the heating and pressing apparatus 144 may be an apparatus combining a heating and pressing roller and a pressing belt, an apparatus combining a pressing roller and a heating and pressing belt, or the like.

The cleaner 116 is provided for the purpose of removing and collecting the transferred residual toner particles remaining on the surface of the photoreceptor 110 after the transfer of the toner image.

The image forming apparatus 100 may be further provided with an erasing device (not shown) for erasing the charge on the surface of the photoreceptor 110 after the transfer and before the next charging.

A description will be given below of the image forming method of the image forming apparatus 100.

The charging apparatus 112, the exposure apparatus 114, the developing apparatus 120, the transfer apparatus 130, the fixing apparatus 140, and the cleaner 116 are operated in synchronization with the rotation speed of the photoreceptor 110.

First, the charging apparatus 112 charges the surface of the photoreceptor 110 rotating in the direction of arrow B to a predetermined potential.

Next, the exposure apparatus 114 exposes the charged surface of the photoreceptor 110 based on an image signal to form an electrostatic charge image.

In the developing apparatus 120, the developer supply roller 124 supplies the liquid developer G to the surface of the developing roller 128, and the developing roller 128 rotating in the direction of arrow A transports the liquid developer G to the photoreceptor 110.

The liquid developer G is supplied to the electrostatic charge image on the photoreceptor 110 at a position where the developing roller 128 and the photoreceptor 110 are brought close to (or in contact with) each other, and develops (visualizes) the electrostatic charge image to form a toner image T.

Next, the toner image T on the surface of the photoreceptor 110 is transferred onto the surface of the intermediate transfer member 132 rotating in the direction of arrow C.

Next, the toner image T transferred to the surface of the intermediate transfer member 132 is transferred to the recording medium P at the contact position with the transfer roller 134. This transfer is carried out by nipping the recording medium P between the transfer roller 134 and the intermediate transfer member 132 and bringing the toner image T on the surface of the intermediate transfer member 132 into close contact with the recording medium P.

The recording medium P to which the toner image T is transferred is transported to the fixing apparatus 140 and passes through the non-contact heating apparatus 142 and the heating and pressing apparatus 144 in this order to form a fixed image on the surface of the recording medium P.

In a case where a thermoplastic resin film is used as the recording medium P, the heating temperature of the non-contact heating apparatus 142 is preferably from 70° C. to less than 110° C., more preferably from 80° C. to 100° C., and even more from preferably 80° C. to 90° C. The heating time is determined by the processing speed of the non-contact heating apparatus 142.

The toner image heated by the non-contact heating apparatus 142 is further heated and pressed by a heating and pressing apparatus 144 (the heating roller 144A and the pressing roller 144B) to be fixed on the recording medium P.

In a case where a thermoplastic resin film is used as the recording medium P, the heating temperature of the heating and pressing apparatus 144 is preferably from 70° C. to less than 110° C., more preferably from 80° C. to 100° C., and even more preferably from 80° C. to 90° C. The pressure applied by the heating and pressing apparatus 44 is preferably from 1.5 kg/cm² to 5 kg/cm², and more preferably from 2 kg/cm² to 3.5 kg/cm².

After the toner image T is transferred to the intermediate transfer member 132, the transferred residual toner is removed and collected from the photoreceptor 110 using the cleaner 116, and returns to the charging step again.

The image forming apparatus 100 maybe a tandem type full color image forming apparatus, in which the photoreceptor 110, the charging apparatus 112, the exposure apparatus 114, the developing apparatus 120, the transfer apparatus 130, and the cleaner 116 are one unit, and four of these units are lined up and mounted therein.

The image forming apparatus 100 maybe of a type in which toner particles or externally added toner is supplied from a toner cartridge (not shown) to the developer accommodating container 122, or of a type in which a liquid developer is supplied from a liquid developer cartridge (not shown). The toner cartridge or the liquid developer cartridge may have a configuration which is detachable from the image forming apparatus so as to be replaceable when the remaining amount of the liquid developer runs out.

### EXAMPLES

A detailed description will be given below of exemplary embodiments of the present invention using Examples, but the exemplary embodiments of the invention are not limited to these examples. In the following description, “parts” and “%” are all based on weight unless otherwise specified.

### <Amorphous Polyester Resin 1>

42 equivalents by mole of terephthalic acid, 8 equivalents by mole of trimellitic anhydride, 42 equivalents by mole of bisphenol A propylene oxide 2 mole adduct, 8 equivalents by mole of ethylene glycol, and dibutyltin oxide as a catalyst are put in a heated and dried two-necked flask, then air in the container is set to an inert atmosphere by a depressurizing operation with nitrogen gas and stirred by mechanical stirring at 180 rpm for 5 hours. Thereafter, the temperature is slowly raised to 230° C. under reduced pressure, and the mixture is stirred for 24 hours and, when the mixture enters a viscous state, the mixture is air-cooled to stop the reaction, thereby obtaining an amorphous polyester resin 1. As a result of molecular weight measurement by GPC (in terms of polystyrene), the weight average molecular weight (Mw) of the amorphous polyester resin 1 is 42,500.

### <Crystalline Polyester Resin 1>

50 equivalents by mole of sebacic acid, 50 equivalents by mole of 1,4-butanediol, and dibutyltin oxide as a catalyst are put in a heated and dried two-necked flask, then air in the container is set to an inert atmosphere by a depressurizing operation with nitrogen gas and stirred by mechanical stirring at 180 rpm for 3 hours. Thereafter, the temperature is slowly raised to 210° C. under reduced pressure, and the mixture is stirred for 12 hours and, when the mixture enters a viscous state, the mixture is air-cooled to stop the reaction, thereby obtaining a crystalline polyester resin 1. As a result of molecular weight measurement by GPC (in terms of polystyrene), the weight average molecular weight (Mw) of the crystalline polyester resin 1 is 25,600. Here, the C/O ratio is 3.5.

### <Crystalline Polyester Resin 2>

A crystalline polyester resin 2 is obtained in the same manner as in the preparation of the crystalline polyester resin 1, except that the acid component used in crystalline polyester resin 1 is changed to 40 equivalents by mole of sebacic acid and 10 equivalents by mole of adipic acid. The weight average molecular weight (Mw) is 24,000. Here, the C/O ratio is 3.3.

### <Crystalline Polyester Resin 3>

A crystalline polyester resin 3 is obtained in the same manner as in the preparation of the crystalline polyester resin 1 except that the acid component used in crystalline polyester resin 1 is changed to 30 equivalents by mole of sebacic acid and 20 equivalents by mole of succinic acid. The weight average molecular weight (Mw) is 25,000. Here, the C/O ratio is 2.9.

### <Crystalline Polyester Resin 4>

A crystalline polyester resin 4 is prepared in the same manner as in the preparation of the crystalline polyester resin 1 except that the acid component and the alcohol component used in crystalline polyester resin 1 are changed to 5 equivalents by mole of sebacic acid, 45 equivalents by mole of succinic acid, and 50 equivalents by mole of hexanediol. The weight average molecular weight (Mw) is 27,000. Here, the C/O ratio is 2.65.

### <Crystalline Polyester Resin 5>

A crystalline polyester resin 5 is prepared in the same manner as in the preparation of the crystalline polyester resin 1, except that the acid component and the alcohol component used in crystalline polyester resin 1 are changed to 50 equivalents by mole of adipic acid, 40 equivalents by mole of butanediol, and 10 equivalents by mole of ethylene glycol. The weight average molecular weight (Mw) is 30,000. Here, the C/O ratio is 2.4.

### <Crystalline Polyester Resin 6>

A crystalline polyester resin 6 is prepared in the same manner as in the preparation of the crystalline polyester resin 1, except that the acid component and the alcohol component used in crystalline polyester resin 1 are changed to 40 equivalents by mole of adipic acid, 10 equivalents by mole of sebacic acid, and 50 equivalents by mole of ethylene glycol. The weight average molecular weight (Mw) is 25,000. Here, the C/O ratio is 2.2.

### <Crystalline Polyester Resin 7>

A crystalline polyester resin 7 is prepared in the same manner as in the preparation of the crystalline polyester resin 1, except that the acid component and the alcohol component used in the crystalline polyester resin 1 are changed to 20 equivalents by mole of adipic acid, 30 equivalents by mole of succinic acid, 40 equivalents by mole of ethylene glycol, and 10 equivalents by mole of butanediol. The weight average molecular weight (Mw) is 31,000. Here, the C/O ratio is 1.8.

### <Liquid Developer 1>

50 parts by weight of the amorphous polyester resin 1 obtained as described above, 25 parts by weight of the crystalline polyester 1, 15 parts by weight of C.I. Pigment Red 238 (azo pigment), and 10 parts by weight of carnauba wax are mixed with a HENSCHEL MIXER and then kneaded using a BANBURY MIXER, and the cooled material is coarsely pulverized to 2 mm square or less to obtain a coarsely pulverized product.

Thereafter, 20 parts by weight of the coarsely pulverized particles and 80 parts by weight of isoparaffin (trade name: ISOPAR L, EXXON MOBIL CORPORATION) are mixed and pulverized using a ball mill and zirconia beads having a diameter of 5 mm for 168 hours to prepare a liquid developer 1. When the particle diameter is measured with a laser diffraction/scattering type particle diameter distribution measuring apparatus (LA-960 manufactured by HORIBA LTD.), the volume average particle diameter is 1.6 μm. The crystal melting peak is 58° C.

### <Liquid Developer 2>

A liquid developer 2 is prepared in the same manner as in the preparation of the liquid developer 1, except that the amorphous polyester resin 1 is changed to 55 parts by weight, a crystalline polyester 2 to 25 parts by weight, and the carnauba wax to 5 parts by weight with respect to the liquid developer 1. The volume average particle diameter is 1.6 μm. The crystal melting peak is 61° C.

### <Liquid Developer 3>

A liquid developer 3 is prepared in the same manner as in the preparation of the liquid developer 1, except that the amorphous polyester resin 1 is changed to 55 parts by weight, a crystalline polyester 3 to 25 parts by weight, and the carnauba wax to 5 parts by weight with respect to the liquid developer 1. The volume average particle diameter is 1.8 μm. The crystal melting peak is 61° C.

### <Liquid Developer 4>

A liquid developer 4 is prepared in the same manner as in the preparation of the liquid developer 1, except that the amorphous polyester resin 1 is changed to 56 parts by weight, a crystalline polyester 4 to 25 parts by weight, and the carnauba wax to 4 parts by weight with respect to the liquid developer 1. The volume average particle diameter is 1.6 μm. The crystal melting peak is 63° C.

### <Liquid Developer 5>

A liquid developer 5 is prepared in the same manner as in the preparation of the liquid developer 1, except that the amorphous polyester resin 1 is changed to 56 parts by weight, a crystalline polyester 5 to 25 parts by weight, and the carnauba wax to 4 parts by weight with respect to the liquid developer 1. The volume average particle diameter is 1.9 μm. The crystal melting peak is 63° C.

### <Liquid Developer 6>

A liquid developer 6 is prepared in the same manner as in the preparation of the liquid developer 1, except that the amorphous polyester resin 1 is changed to 55 parts by weight, a crystalline polyester 6 to 25 parts by weight, and the carnauba wax to 5 parts by weight with respect to the liquid developer 1. The volume average particle diameter is 2.0 μm. The crystal melting peak is 64° C.

### <Liquid Developer 7>

A liquid developer 7 is prepared in the same manner as in the preparation of the liquid developer 1, except that the amorphous polyester resin 1 is changed to 54 parts by weight, a crystalline polyester 7 to 25 parts by weight, and the carnauba wax to 6 parts by weight with respect to the liquid developer 1. The volume average particle diameter is 2.2 μm. The crystal melting peak is 65° C.

### <Evaluation of Image Graininess (Heat Storability)>

Using each of the liquid developers 1 to 7 after allowing the liquid developers 1 to 7 to stand at 40° C. for 24 hours, a patch having a size of 20 mm×20 mm and an image density of 10% is formed on plain paper, and with respect to thus-formed ten patch images, the uniformity of the formed image is visually evaluated. Since a developer having a poor storability causes roughness in the outputted image due to aggregation or the like, the heat storability is evaluated.

The evaluation criteria are as follows. Here, the ranges acceptable in practice are G1 to G3.

G1: Rough feeling for any patch image is not confirmed.

G2: Rough feeling is observed in one or two patch images.

G3: Rough feeling is observed in three or four patch images.

G4: There is a rough feeling in five or more patch images.

The liquid developers 1 to 7 each are evaluated. The results are shown in Table 1.

TABLE 1

| | | Crystalline polyester resin | | | | |
|---|---|---|---|---|---|---|
| | | | | | Content | |
| | | | | | with respect | |
| | | | | | to total | |
| | | | | | weight of | |
| | | | | Crystal | binder resin | |
| | | | | melt | included | |
| | | | | peak | in toner | Evaluation |
| | | | | temper- | particles | Graininess |
| | Liquid | | C/O | ature | (% by | (heat |
| | developer | No. | ratio | (° C.) | weight) | storability) |
| Example 1 | 2 | 2 | 3.3 | 61 | 31 | G1 |
| Example 2 | 3 | 3 | 2.9 | 61 | 31 | G1 |
| Example 3 | 4 | 4 | 2.65 | 63 | 31 | G1 |
| Example 4 | 5 | 5 | 2.4 | 63 | 31 | G2 |
| Example 5 | 6 | 6 | 2.2 | 64 | 33 | G3 |
| Comparative | 1 | 1 | 3.5 | 58 | 33 | G4 |
| Example 1 | | | | | | |
| Comparative | 7 | 7 | 1.8 | 65 | 32 | G4 |
| Example 2 | | | | | | |

It is apparent from the results of the Examples and Comparative Examples shown in Table 1 that the liquid developers according to the exemplary embodiment prevent the generation of a rough feeling in the outputted image and have an excellent heat storability.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A liquid developer comprising:
toner particles; and
a carrier liquid,
wherein the toner particles include, as a binder resin, an amorphous polyester resin and a crystalline saturated aliphatic polyester resin having a composition ratio (C/O ratio) of carbon atoms and oxygen atoms of 3.4 or less, and
with respect to a toner obtained by vacuum drying the toner particles, a crystal melting peak at a first temperature rise in differential heating calorimetry is 60° C. or more.

2. The liquid developer according to claim 1,
wherein the crystalline saturated aliphatic polyester resin is a resin having a constituent unit represented by formula (1): 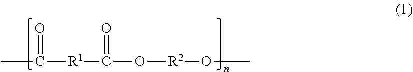
wherein R¹ and R² each independently represent an alkylene group, a total number of carbon atoms of R¹ and R² is from 8 to 14, and n represents a number of 2 or more.

3. The liquid developer according to claim 1,
wherein a content of the crystalline saturated aliphatic polyester resin is from 5% by weight to 40% by weight with respect to a total weight of the binder resin included in the toner particles.

4. The liquid developer according to claim 1,
wherein the crystal melting peak is from 60° C. to 80° C.

5. The liquid developer according to claim 1,
wherein the crystalline saturated aliphatic polyester resin has a weight average molecular weight (Mw) of more than 5,000.

6. The liquid developer according to claim 1,
wherein the amorphous polyester resin has a weight average molecular weight (Mw) of from 5,000 to 1,000,000.

7. The liquid developer according to claim 1,
wherein an SP value (unit: (cal/cm³)^{1/2}) of the amorphous polyester resin is from 9.50 to 10.00.

8. The liquid developer according to claim 1,
wherein a molecular weight distribution Mw/Mn of the amorphous polyester resin is from 1.5 to 100.

9. The liquid developer according to claim 1, further comprising at least one compound selected from the group consisting of a polyalkyleneimine compound and a polyallylamine compound as a dispersant.

10. The liquid developer according to claim 9,
wherein the polyallylamine compound is a copolymer represented by formula (PAA): 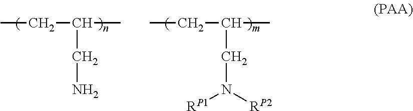
wherein R^{P1} and R^{P2} each independently represents a hydrogen atom or an aliphatic hydrocarbon group having 1 to 20 carbon atoms, and n and m each independently represent an integer from 1 to 10,000.

11. The liquid developer according to claim 1, further comprising at least one compound selected from the group consisting of a maleimide compound, a toluenesulfonamide compound, a metal soap of octylic acid, a metal soap of octanoic acid, and a metal soap of naphthenic acid as a charge-controlling agent.

12. The liquid developer according to claim 1,
wherein the carrier liquid includes a mineral oil.

13. The liquid developer according to claim 2,
wherein the carrier liquid includes a mineral oil.

14. The liquid developer according to claim 1,
wherein an electric conductivity of the carrier liquid is 10⁻¹⁰ S/m or less.

15. The liquid developer according to claim 1,
wherein the carrier liquid has a flash point of 130° C. or more.

16. The liquid developer according to claim 1,
wherein the carrier liquid includes paraffin in an amount of 50% by weight or more.

17. The liquid developer according to claim 1,
wherein a volume particle size distribution index (GSDv) of the toner particles is 1.5 or less.

18. The liquid developer according to claim 1,
wherein the toner particles include a colorant in an amount of from 1% by weight to 30% by weight with respect to a total weight of the toner particles.

19. The liquid developer according to claim 1,
wherein a content of the toner particles is from 10 parts by weight to 35 parts by weight with respect to 100 parts by weight of the carrier liquid.

20. A liquid developer cartridge comprising:
a container that contains the liquid developer according to claim 1,
wherein the liquid developer cartridge is detachable from an image forming apparatus.
